(19) United States
(12) Patent Application Publication
(10) Pub. No.: US 2014/0111713 A1
(43) Pub. Date: Apr. 24, 2014

(54) LIQUID CRYSTAL OPTICAL ELEMENT AND IMAGE DEVICE

(71) Applicant: Kabushiki Kaisha Toshiba, Minato-ku (JP)

(72) Inventors: Yuko KIZU, Kanagawa-ken (JP); Machiko ITO, Kanagawa-ken (JP); Ayako TAKAGI, Kanagawa-ken (JP); Shinichi UEHARA, Tokyo (JP)

(73) Assignee: Kabushiki Kaisha Toshiba, Minato-ku (JP)

(21) Appl. No.: 13/971,192

(22) Filed: Aug. 20, 2013

(30) Foreign Application Priority Data
Oct. 23, 2012 (JP) 2012-233450

(51) Int. Cl. G02F 1/13; G02F 1/1343

(52) U.S. Cl. CPC G02F 1/1313; G02F 1/134327
USPC 349/15; 349/142; 349/130

(57) ABSTRACT

According to an embodiment, a liquid crystal optical element includes a first substrate unit, a second substrate unit and a liquid crystal layer provided therebetween. The first substrate unit includes a first substrate, a plurality of first electrodes provided thereon and a second electrode provided between two most proximal first electrodes. The second electrode is asymmetric with respect to a central axis between one electrode of the two most proximal first electrodes and the other electrode thereof. The second substrate unit includes a second substrate opposing the first substrate, and an opposing electrode provided on the second substrate. The liquid crystal layer has a first portion on the first substrate unit side and a second portion on the second substrate unit side; and a liquid crystal in the first portion has a vertical alignment, and a liquid crystal in the second portion has a horizontal alignment.

### CROSS-REFERENCE TO RELATED APPLICATIONS

This application is based upon and claims the benefit of priority from Japanese Patent Application No.2012-233450, filed on Oct. 23, 2012; the entire contents of which are incorporated herein by reference.

### FIELD

Embodiments are generally related to a liquid crystal optical element and an imaging device.

### BACKGROUND

There is a liquid crystal optical element that changes the distribution of the refractive index according to the application of a voltage by utilizing the birefringence of liquid crystal molecules. Also, there is a stereoscopic image display device in which such a liquid crystal optical element is combined with an image display unit.

By changing the distribution of the refractive index of the liquid crystal optical element, the stereoscopic image display device switches between a state in which the image displayed by the image display unit is caused to be incident on the eyes of a human viewer as displayed by the image display unit and a state in which the image displayed by the image display unit is caused to be incident on the eyes of the human viewer as multiple parallax images. Thereby, a high definition two-dimensional image display operation and a three-dimensional image display operation are realized, where the three-dimensional image display operation includes autostereoscopic viewing due to the multiple parallax images. It is desirable to realize good optical characteristics of the liquid crystal optical element used in the stereoscopic image display device.

### BRIEF DESCRIPTION OF THE DRAWINGS

FIG. 1 is a schematic cross-sectional view showing a liquid crystal optical element according to a first embodiment;

FIG. 2 is a schematic view showing an image device according to the first embodiment;

FIG. 3 is a schematic perspective view showing the image device according to the first embodiment;

FIGS. 4A and 4B are schematic cross-sectional views showing the operation of the image device according to the first embodiment;

FIG. 5 is a schematic cross-sectional view showing a liquid crystal optical element according to a reference example;

FIG. 6 is a schematic cross-sectional view showing the liquid crystal optical element according to the first embodiment;

FIG. 7 is a graph showing characteristics of the liquid crystal optical elements;

FIG. 8 is a schematic cross-sectional view showing a liquid crystal optical element according to a second embodiment;

FIG. 9 is a schematic cross-sectional view showing the liquid crystal optical element according to the reference example;

FIG. 10 is a schematic cross-sectional view showing a liquid crystal optical element according to the second embodiment;

FIG. 11 is a graph showing characteristics of the liquid crystal optical elements;

FIG. 12 is a schematic perspective view showing an image device according to a third embodiment; and

FIG. 13 is a schematic cross-sectional view showing an image device according to a fourth embodiment.

### DETAILED DESCRIPTION

According to an embodiment, a liquid crystal optical element includes a first substrate unit, a second substrate unit and a liquid crystal layer provided between the first substrate unit and the second substrate unit. The first substrate unit includes a first substrate having a first major surface, a plurality of first electrodes provided on the first major surface to extend along a first direction, and a second electrode provided between two most proximal first electrodes of the plurality of first electrodes on the first major surface. The second electrode extends along the first direction; and the second electrode is asymmetric with respect to a central axis, which is parallel to the first direction, and passes through a midpoint of a line segment connecting a center in a second direction of one electrode of the two most proximal first electrodes to a center in the second direction of the other electrode of the most proximal first electrodes, where the second direction is parallel to the first major surface and perpendicular to the first direction. The second substrate unit includes a second substrate having a second major surface opposing the first major surface, and an opposing electrode provided on the second major surface to oppose the first electrodes and the second electrode. The liquid crystal layer has a first portion on the first substrate unit side and a second portion on the second substrate unit side; a liquid crystal in the first portion has a vertical alignment; and a liquid crystal in the second portion has a horizontal alignment along the second direction.

Embodiments will now be described in detail with reference to the drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

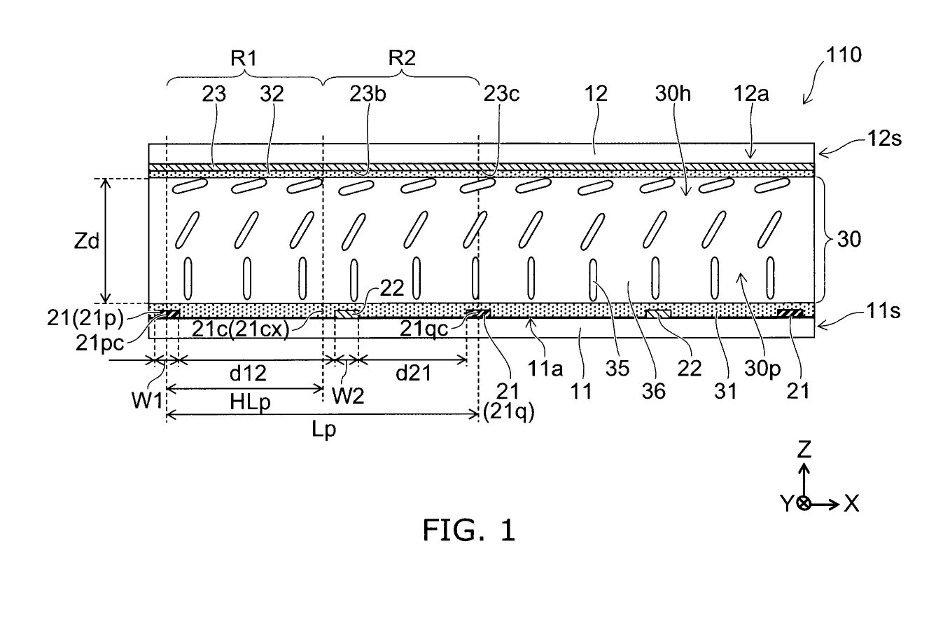

FIG. 1 is a schematic cross-sectional view showing the configuration of a liquid crystal optical element according to a first embodiment.

As shown in FIG. 1, the liquid crystal optical element 110 includes a first substrate unit 11s, a second substrate unit 12s, and a liquid crystal layer 30.

The first substrate unit 11s includes a first substrate 11, multiple first electrodes 21, and a second electrode 22.

The first substrate 11 has a first major surface 11a. The multiple first electrodes 21 are provided on the first major surface 11a. The first electrodes 21 extend along a first direction. The first direction is any direction parallel to the first major surface 11a.

A direction perpendicular to the first major surface 11a is taken as a Z-axis direction. One direction perpendicular to the Z-axis direction is taken as an X-axis direction. A direction perpendicular to the Z-axis direction and the X-axis direction is taken as a Y-axis direction. For example, the Y-axis direction is taken to be the first direction. The X-axis direction is taken to be the second direction. In the description hereinbelow, the +X axis direction is the positive direction of the X axis; and the −X axis direction is the negative direction of the X axis. This is similar for the Y-axis direction and the Z-axis direction.

The second electrode 22 is provided on the first major surface. The second electrode 22 extends in the first direction (the Y-axis direction) between two most proximal first electrodes 21 of the multiple first electrodes 21. For example, the second electrode 22 is provided between one electrode 21p of the two most proximal first electrodes 21 and the other electrode 21q of the most proximal first electrodes 21. The second electrode 22 is provided in each space between the two most proximal first electrodes 21.

The spacing between the multiple first electrodes 21 and the spacing between the second electrodes 22 is, for example, constant. The pattern configuration of the first electrode 21 and the pattern configuration of the second electrode 22 are, for example, band configurations. Examples of the disposition of the first electrodes 21 and the second electrode 22 are described below.

The second substrate unit 12s includes a second substrate 12 and an opposing electrode 23. The second substrate 12 has a second major surface 12a. The second major surface 12a opposes the first major surface 11a. The second major surface 12a is substantially parallel to the first major surface 11a. The opposing electrode 23 is provided on the second major surface 12a. The opposing electrode 23 opposes each of the multiple first electrodes 21 and the multiple second electrodes 22. The opposing electrode 23 has a portion 23c opposing the first electrode 21 and a portion 23b opposing the second electrode 22.

Although the opposing electrode 23 is shown as a continuous body provided on the second major surface 12a in FIG. 1, this is not limited thereto. For example, the opposing electrode 23 may be provided in a configuration having slits.

The liquid crystal layer 30 is provided between the first substrate unit 11s and the second substrate unit 12s. The liquid crystal layer 30 includes a liquid crystal 36 including multiple liquid crystal molecules 35. The liquid crystal 36 is a liquid crystal medium. The liquid crystal layer 30 may include, for example, a nematic liquid crystal. The dielectric anisotropy of the liquid crystal layer 30 is positive or negative. Hereinbelow, the case will be described where a nematic liquid crystal having a positive dielectric anisotropy is used as the liquid crystal layer 30.

A first alignment film 31 is provided between the liquid crystal layer 30 and the first electrodes 21 and between the liquid crystal layer 30 and the second electrode 22. The first alignment film 31 is included in the first substrate unit 11s. The first alignment film 31 causes the liquid crystal molecules 35 to have a vertical alignment. As described below, the director of the liquid crystal 36 on the side of first substrate unit 11s may not have a rigorous vertical alignment.

A second alignment film 32 is provided between the opposing electrode 23 and the liquid crystal layer 30. The second alignment film 32 is included in the second substrate unit 12s. The second alignment film 32 causes the liquid crystal molecules 35 to have a horizontal alignment. The second alignment film 32 causes the director (the long axis) of the liquid crystal 36 to be along the X-axis direction. In the embodiment, the liquid crystal 36 director may not be rigorously parallel to the X-axis direction. The absolute value of the angle between the director and the component of the director projected onto the first major surface 11a is not more than 15 degrees. The state in which the director of the liquid crystal 36 has the horizontal alignment is taken to be the state in which the absolute value of the angle between the director and the component projected onto the first major surface 11a is not more than 15 degrees.

A HAN (Hybrid Aligned Nematic) alignment is formed in the state (the inactive state) in which a voltage is not applied between the opposing electrode 23 and the first electrodes 21 and between the opposing electrode 23 and the second electrodes 22. In the HAN alignment, the alignment is the vertical alignment on the first substrate side and is the horizontal alignment on the second substrate side. A first portion 30p of the liquid crystal layer 30 on the side of first substrate unit 11s has the vertical alignment. A second portion 30h of the liquid crystal layer 30 on the side of second substrate unit 12s has the horizontal alignment. In the horizontal alignment, the long axis of the liquid crystal molecules 35 is along the X-axis direction.

In the horizontal alignment, the pretilt angle is not less than 0° and not more than 30°. The pretilt angle is the angle between the director of the liquid crystal 36 and the first major surface 11a. In the vertical alignment, the pretilt angle is not less than 60° and not more than 90°. The alignment axis is parallel to the horizontal side.

The direction of the pretilt is the direction to which the director of the liquid crystal 36 tilts on the X-Y plane. For example, the direction of the pretilt can be determined by a crystal rotation method. Also, the direction of the pretilt can be determined by changing the alignment of the liquid crystal by applying a voltage to the liquid crystal layer 30 and by observing the optical characteristics of the liquid crystal layer 30 at this time.

The first substrate 11, the second substrate 12, the first electrode 21, the second electrode 22, and the opposing electrode 23 may include transparent materials. The first substrate 11 and the second substrate 12 may include, for example, glass, a resin, etc. The first electrode 21, the second electrode 22, and the opposing electrode 23 include, for example, an oxide including at least one element selected from the group consisting of In, Sn, Zn, and Ti. The first electrode 21, the second electrode 22, and the opposing electrode 23 may include, for example, ITO (Indium Tin Oxide). The first electrode 21, the second electrode 22, and the opposing electrode 23 may include a thin metal layer.

The first alignment film 31 and the second alignment film 32 may include, for example, polyimide. The material of the first alignment film 31 is different from the material of the second alignment film 32. For example, the surface energy of the second alignment film 32 is greater than the surface energy of the first alignment film 31.

The one electrode 21p of the two most proximal first electrodes 21 and the other electrode 21q of the most proximal first electrodes 21 of the first substrate unit 11s will now be focused upon. A central axis 21cx exists between the one electrode 21p recited above and the other electrode 21q recited above. The central axis 21cx is parallel to the Y-axis direction (the first direction) to pass through a midpoint 21c of the line segment connecting a second-direction center 21pc of the one electrode 21p recited above to a second-direction center 21qc of the other electrode 21q recited above.

The region between the straight line that is orthogonal to the first major surface 11a and passes through the central axis 21cx and the straight line that is orthogonal to the first major surface 11a and passes through the center 21pc of the one electrode 21p recited above is taken as a first region R1. The region between the straight line that is orthogonal to the first major surface 11a and passes through the central axis 21cx and the straight line that is orthogonal to the first major surface 11a and passes through the center 21qc of the other electrode 21q recited above is taken as a second region R2.

The second electrode 22 is asymmetric with respect to the central axis 21cx. In the example, one second electrode 22 is provided between the two most proximal first electrodes 21 (between the one electrode 21p and the other electrode 21q).

The second electrode 22 is provided in the second region R2; and the second electrode 22 is not provided in the first region R1. Thus, the state in which the second electrode 22 is asymmetric with respect to the central axis 21cx includes the state in which the second electrode 22 is provided in one region between the two first electrodes 21 partitioned by the central axis 21cx and the second electrode 22 is not provided in the other region between the two first electrodes 21 partitioned by the central axis 21cx.

In the case where one second electrode 22 is provided between the two first electrodes 21, the state in which the second electrode 22 is asymmetric with respect to the central axis 21cx includes the state in which the second-direction center of the second electrode 22 does not overlap the central axis 21cx.

Two or more second electrodes 22 may be provided between the two first electrodes 21. In such a case, the multiple second electrodes 22 are asymmetric with respect to the central axis 21cx.

In the case where one second electrode 22 is provided between the one electrode 21p recited above and the other electrode 21q recited above, the distance (the distance in the X-axis direction) between the one electrode 21p and the second electrode 22 is taken as a first distance d12. The distance (the distance in the X-axis direction) between the other electrode 21q and the second electrode 22 is taken as a second distance d21. In the example, the first distance d12 is longer than the second distance d21.

The positional relationship between the second electrode 22 and the first electrodes 21 is represented by the following formulas.

Lp=W1+d12+W2+d21 (1)

HLp=Lp/2 (2)

d12>d21 (3)

Here, Lp is the distance between the centers of the mutually-adjacent first electrodes 21. HLp is half the distance from the center of the first electrode 21 to the center of an adjacent first electrode 21.

The width of the first electrode 21 in the X-axis direction is taken as the first width W1. The width of the second electrode 22 in the X-axis direction is taken as the second width W2. For example, the absolute value of the difference between the first distance d12 and the second distance d21 (Δd=|d12−d21|) may be greater than at least one selected from the first width W1 and the second width W2. In the example, the absolute value of the difference (Δd=|d12−d21) is greater than the first width W1 and greater than the second width W2.

The position of the second electrode 22 in the X-axis direction does not match the central axis 21cx.

|d12−d21|>W1 (4)

|d12−d21|>W2 (5)

The thickness (in the Z-axis direction) of the liquid crystal layer 30 is taken as Zd. For example, Zd is not less than 2 micrometers (gm) and not more than 200 μm. For example, Lp is not less than 10 μm and not more than 600 μm. W1 is, for example, not less than 1 μm and not more than 50 μm. W2 is, for example, not less than 1 μm and not more than 500 μm. For example, Δd is not less than 0.5 times W1 and not more than 50 times W1. For example, Δd is not less than 0.5 times W2 and not more than 50 times W2. For example, Δd is not less than 2% of Lp and not more than 95% of Lp.

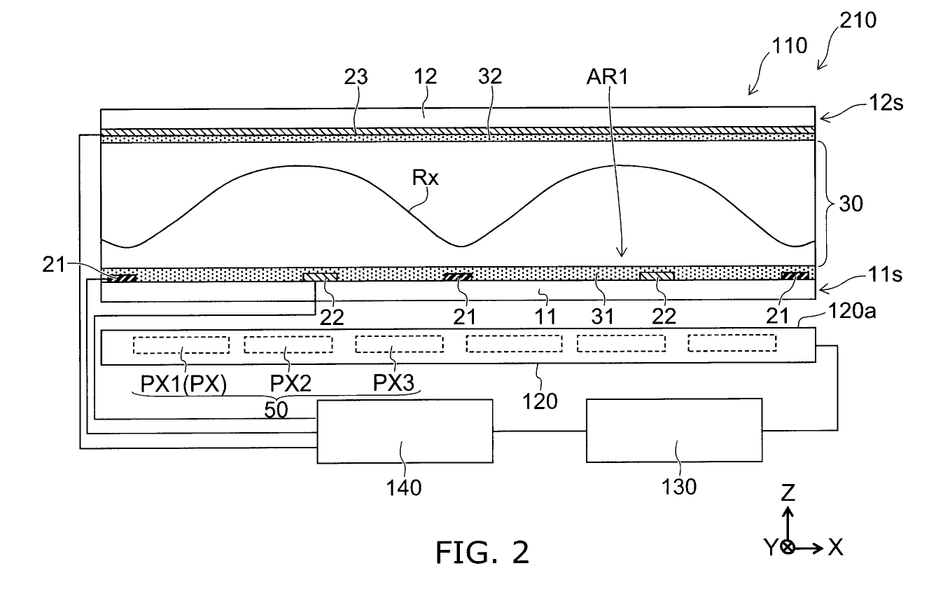

FIG. 2 is a schematic view showing the configuration of an image device according to the first embodiment.

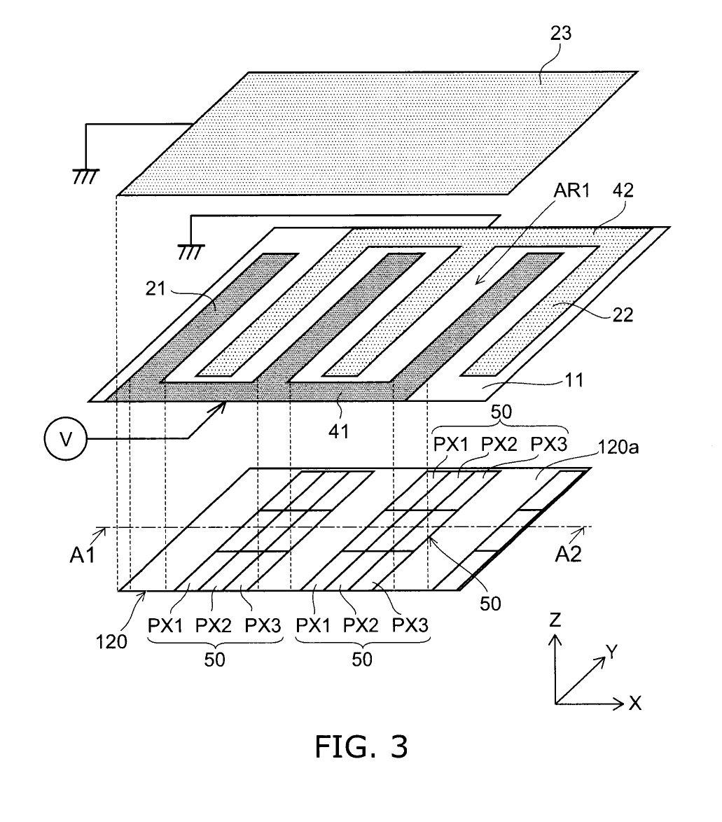

FIG. 3 is a schematic perspective view showing the configuration of the image device according to the first embodiment.

In the example, the image device is an image display device 210.

As shown in FIG. 2 and FIG. 3, the image display device 210 (the image device) includes the liquid crystal optical element 110, an image display unit 120 (an image unit), a display control circuit 130, and a control circuit 140. The image display unit 120 includes pixels.

The image display unit 120 has an image display surface 120a for displaying an image. The image display surface 120a has, for example, a rectangular configuration. The image display unit 120 is stacked with the liquid crystal optical element 110. The state of being stacked includes not only the state of directly overlapping but also the state of overlapping to be separated from each other and the state of overlapping with another component inserted therebetween.

The liquid crystal optical element 110 is provided on the image display surface 120a. The liquid crystal optical element 110 covers, for example, the entire image display surface 120a.

The display control circuit 130 is electrically connected to the image display unit 120. The control circuit 140 is electrically connected to the liquid crystal optical element 110. The display control circuit 130 controls the operation of the image display unit 120. For example, an image signal is input to the display control circuit 130 from a recording medium, an external input, etc. The display control circuit 130 controls the operation of the image display unit 120 based on the image signal that is input. An image corresponding to the image signal that is input is displayed at the image display surface 120a. The display control circuit 130 may be included in the image display unit 120. The display control circuit 130 may include the control circuit 140.

The control circuit 140 is electrically connected to the first electrodes 21, the second electrodes 22, and the opposing electrode 23. For example, the control circuit 140 is connected to the display control circuit 130. For example, the control circuit 140 operates based on a signal supplied from the display control circuit 130. The control circuit 140 supplies a voltage to the liquid crystal layer 30 to form a refractive index distribution Rx in the liquid crystal layer 30 of the liquid crystal optical element 110.

In the voltage application state, the liquid crystal optical element 110 has the refractive index distribution Rx in the X-axis direction and functions as, for example, a liquid crystal GRIN lens (Gradient Index lens). The state of the refractive index distribution Rx of the liquid crystal optical element 110 is changeable. One state of the refractive index distribution Rx corresponds to a first state in which the image displayed on the image display surface 120a is caused to be incident on the eyes of a human viewer as displayed on the image display surface 120a. One other state of the refractive index distribution Rx corresponds to a second state in which the image displayed on the image display unit 120 is caused to be incident on the eyes of the human viewer as multiple parallax images.

In the image display device 210, it is possible to selectively switch between a display of a two-dimensional image (hereinbelow, called a 2D display) and a display of a three-dimensional image (hereinbelow, called a 3D display) by changing the refractive index distribution Rx of the liquid crystal optical element 110. In the display of the three-dimensional image, autostereoscopic viewing is provided.

For example, the control circuit 140 performs the switching between the first state and the second state of the liquid crystal optical element 110.

In the case where the 2D display is performed in the image display device 210, the control circuit 140 switches the liquid crystal optical element 110 to the first state; and the display control circuit 130 causes the image display unit 120 to display an image for the 2D display. On the other hand, in the case where the 3D display is performed in the image display device 210, the control circuit 140 switches the liquid crystal optical element 110 to the second state; and the display control circuit 130 causes the image display unit 120 to display an image for the 3D display.

As shown in FIG. 3, the image display unit 120 has the image display surface 120a that has a rectangular configuration. The image display surface 120a has two sides that are perpendicular to each other. One side of the two sides that are perpendicular to each other is parallel to the X-axis direction. The other side is parallel to the Y-axis direction. The orientations of the sides of the image display surface 120a may be any direction perpendicular to the Z-axis direction.

The image display unit 120 includes multiple pixel groups 50 arranged in a two-dimensional matrix configuration. The image display surface 120a is formed of the multiple pixel groups 50. The pixel group 50 includes a first pixel PX1, a second pixel PX2, and a third pixel PX3. Hereinbelow, the first pixel PX1 to the third pixel PX3 are collectively called the pixels PX. The pixel groups 50 are disposed to oppose a region AR1 between two mutually-adjacent first electrodes 21. The first pixel PX1 to the third pixel PX3 that are included in the pixel group 50 are arranged in the X-axis direction. The number of the multiple pixels PX included in the pixel group 50 is arbitrary.

For example, the image display unit 120 emits light including the image displayed by the image display surface 120a. For example, the light is in a linearly polarized light state to travel substantially in the Z-axis direction. The polarizing axis (the orientation axis in the X-Y plane of the vibration plane of the electric field) of the linearly polarized light is in the X-axis direction. The polarizing axis of the linearly polarized light is in a direction parallel to the director (the long axis) of the liquid crystal molecules 35 on the side of second substrate unit 12s. The linearly polarized light is produced by, for example, disposing an optical filter (a polarizer) having the X-axis direction as the polarizing axis along the optical path.

In the Y-axis direction, the lengths of the first electrodes 21 and the second electrodes 22 of the liquid crystal optical element 110 are longer than the length of the image display surface 120a. The first electrodes 21 and the second electrodes 22 cross the image display surface 120a in the Y-axis direction.

In the example, the ends of the first electrodes 21 are connected to a first interconnect unit 41. The configuration that includes the first electrodes 21 and the first interconnect unit 41 is a comb-like configuration. A voltage is applied to the first electrodes 21 by applying the voltage to the first interconnect unit 41. The ends of the second electrodes 22 are connected to a second interconnect unit 42. The position of the second interconnect unit 42 is on the side opposite to the position of the first interconnect unit 41. A voltage is applied to the second electrodes 22 by applying the voltage to the second interconnect unit 42.

The control circuit 140 controls the potential of the first electrodes 21, the potential of the second electrodes 22, and the potential of the opposing electrode 23. The control circuit 140 controls the voltage between the opposing electrode 23 and the first electrodes 21. The control circuit 140 controls the voltage between the opposing electrode 23 and the second electrodes 22.

In the liquid crystal optical element 110, the switching between the first state and the second state is performed by applying the voltages (setting the potentials) to the first electrodes 21, the second electrodes 22, and the opposing electrode 23.

In the state (the inactive state) in which a voltage is not applied to the liquid crystal layer 30 as shown in FIG. 1, the multiple liquid crystal molecules 35 included in the liquid crystal layer 30 have the vertical alignment on the side of first substrate unit 11s and the horizontal alignment on the side of second substrate unit 12s. This state has a substantially uniform refractive index distribution in the X-axis direction and the Y-axis direction. In the state in which the voltage is not applied, the travel direction of the light including the image displayed on the image display unit 120 substantially does not change. In the case where the voltage is not applied, the liquid crystal optical element 110 is switched to the first state.

In the second state of the liquid crystal optical element 110, for example, a voltage is applied to the first electrodes 21; and the second electrodes 22 and the opposing electrode 23 are grounded. In other words, the absolute value of the voltage between the opposing electrode 23 and the first electrodes 21 is set to be greater than the absolute value of the voltage between the opposing electrode 23 and the second electrodes 22. For example, the effective value of the voltage between the opposing electrode 23 and the first electrodes 21 is set to be greater than the effective value of the voltage between the opposing electrode 23 and the second electrodes 22.

As shown in FIG. 2, in the second state the refractive index distribution Rx of the liquid crystal layer 30 changes along the X-axis direction. The refractive index in the region between the opposing electrode 23 and the first electrode 21 is relatively low. The refractive index in the region between the opposing electrode 23 and the second electrode 22 or in the region proximal to the region between the opposing electrode 23 and the second electrode 22 is relatively high. Thus, the refractive index of the liquid crystal layer 30 changes along the X-axis direction. A refractive index distribution having a convex lens configuration or a configuration approaching a convex lens configuration is formed between the two first electrodes 21.

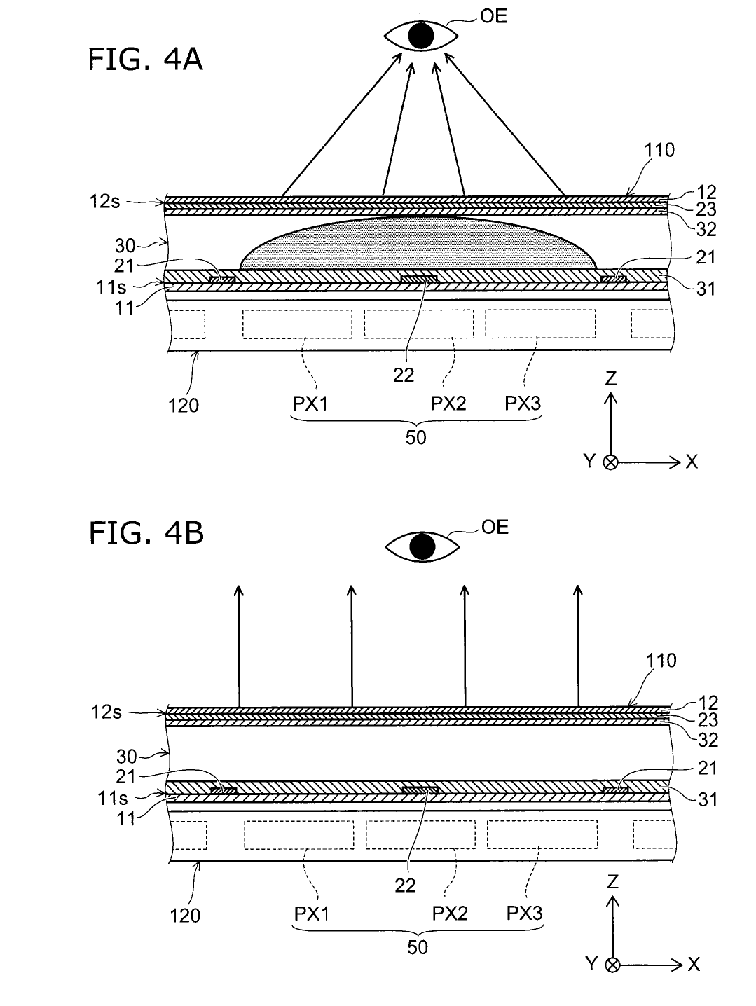

FIG. 4A and FIG. 4B are schematic cross-sectional views showing the operation of the image device according to the first embodiment.

FIG. 4A and FIG. 4B correspond to two different operating states.

As shown in FIG. 4A, the pixel group 50 of the image display unit 120 opposes the region AR1 between two mutually-adjacent first electrodes 21. The refractive index distribution having the convex lens configuration formed in the liquid crystal layer 30 opposes the pixel group 50. In the example, the portion of the refractive index distribution of the liquid crystal layer 30 where the refractive index is high opposes the second pixel PX2 that is disposed in the center of the pixel group 50.

As shown in FIG. 4A, the refractive index distribution of the liquid crystal layer 30 during the voltage application concentrates the light (the image) emitted from the pixel group 50 toward an eye OE of the human viewer. Thereby, the image that is formed of the multiple first pixels PX1 included in the image display surface 120a becomes a first parallax image. The image that is formed of the multiple second pixels PX2 becomes a second parallax image. The image that is formed of the multiple third pixels PX3 becomes a third parallax image. The parallax image for the right eye is selectively incident on the right eye of the human viewer; and the parallax image for the left eye is selectively incident on the left eye of the human viewer. Thereby, the 3D display is possible. In other words, in the case where the voltage is applied, the liquid crystal optical element 110 is switched to the second state.

In the case where the liquid crystal optical element 110 is in the first state as shown in FIG. 4B, the light emitted from the pixel group 50 travels straight and is incident on the eye OE of the human viewer. Thereby, the 2D display is possible. In the 2D display, a normal 2D image can be displayed with a resolution that is greater than that of the 3D display by a factor of the number of parallax images (in this example, three times).

Color filters including the three primary colors RGB may be provided respectively at the multiple pixels PX. Thereby, a color display is possible. Other than the three primary colors RGB, the color filters may further include white (colorless) and other color components.

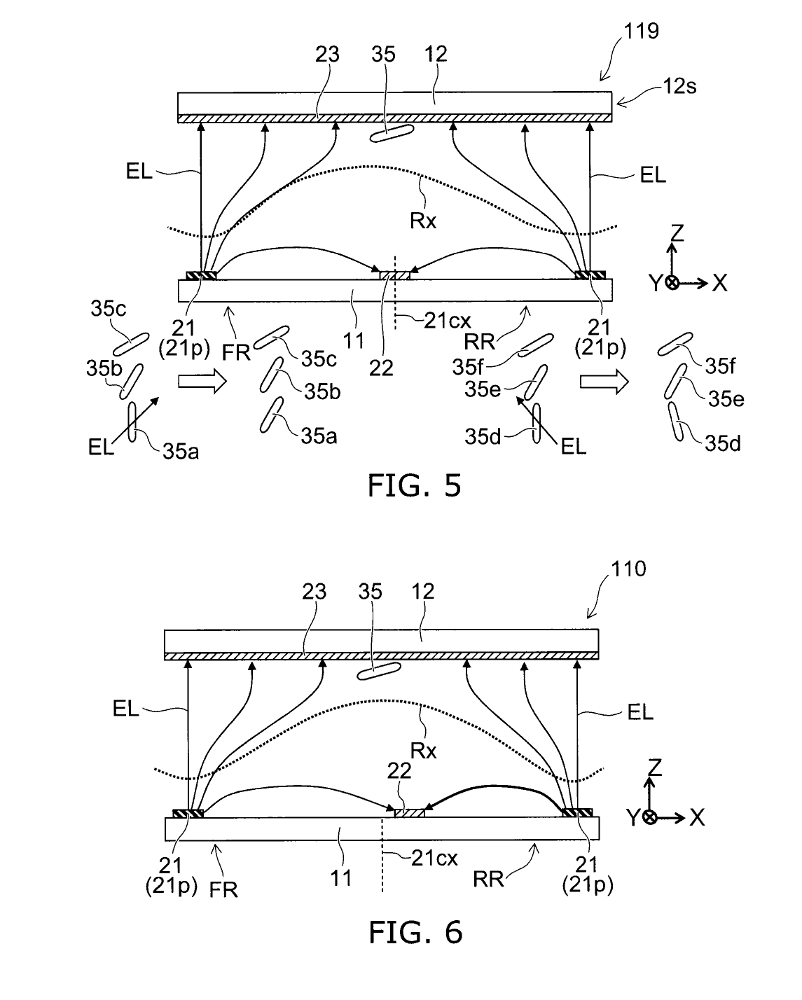

FIG. 5 is a schematic cross-sectional view showing a liquid crystal optical element of a reference example.

The first alignment film 31 and the second alignment film 32 are not shown in FIG. 5.

In the liquid crystal optical element 119 of the reference example as shown in FIG. 5, lines of electric force EL occur around the first electrode 21 when the voltage is applied to the first electrode 21, and the second electrode 22, and the opposing electrode 23 as recited above. In the case where the dielectric anisotropy of the liquid crystal layer 30 is positive, the alignment of the liquid crystal molecules 35 deform along the paths of the lines of electric force EL where the lines of electric force EL are crowded (i.e., the electric field is strong).

In the portion where the first electrode 21 opposes the opposing electrode 23, the alignment of the liquid crystal molecules 35 that had the horizontal alignment on the side of second substrate unit 12s approaches the vertical alignment. On the other hand, in the portion where the second electrode 22 opposes the opposing electrode 23, the alignment of the liquid crystal molecules 35 remains in the horizontal alignment.

In the portion between the second electrode 22 and the first electrode 21, the angle of the liquid crystal molecules 35 changes to gradually approach the vertical alignment from the second electrode 22 toward the first electrode 21. In other words, the liquid crystal molecules 35 conform to the lines of electric force EL; and the angle of the long axis of the liquid crystal molecules 35 changes in the Z-X plane. The angle of the long axis of the liquid crystal molecules 35 changes with the Y-axis direction as the rotational axis.

The liquid crystal molecules 35 have birefringence. The refractive index in the long-axis direction of the liquid crystal molecules 35 for the polarized light is higher than the refractive index in the short-axis direction of the liquid crystal molecules 35. As recited above, when the angle of the liquid crystal molecules 35 is changed, the refractive index of the liquid crystal layer 30 in the X-axis direction for the linearly polarized light is high in the portion of the liquid crystal layer 30 opposing the second electrode 22. The refractive index gradually decreases from the portion opposing the second electrode 22 toward the portion opposing the first electrode 21. Thereby, a refractive index distribution having a convex lens configuration is formed.

The first electrodes 21 and the second electrodes 22 extend along the Y-axis direction. Thereby, the refractive index distribution of the liquid crystal layer 30 during the voltage application has a cylindrical lens configuration that extends along the Y-axis direction. Also, the first electrodes 21 and the second electrodes 22 are multiply arranged alternately in the X-axis direction. Thereby, the refractive index distribution of the liquid crystal layer 30 during the voltage application has a lenticular lens configuration. In the refractive index distribution having the lenticular lens configuration, multiple cylindrical lenses that extend along the Y-axis direction are arranged in the X-axis direction.

In the reference example, the lines of electric force EL are distributed to be, for example, substantially symmetric with the X-axis direction center of the first electrode 21 as the axis of symmetry. However, the refractive index distribution Rx is asymmetric around the X-axis direction center of the first electrode 21.

The density of the lines of electric force EL, i.e., the electric field strength, is strong in the vicinity of the first electrode 21 and becomes weaker away from the first electrode 21 toward the second electrode 22 or the opposing electrode 23. Accordingly, the force that causes the liquid crystal molecules 35 to rotate is strong in the vicinity of the first electrode 21. The lines of electric force EL in the vicinity of the first electrode 21 spread radially. Accordingly, the tilt directions of the lines of electric force EL are mutually reversed at the two ends of the first electrode 21 with the central axes 21cx as boundaries. In a proximal region (a forward region FR) of one of the two ends of the first electrode 21, the direction of the lines of electric force EL is along the direction of the pretilt of the liquid crystal molecules 35. In a proximal region (a reverse region RR) of the other of the two ends of the first electrode 21, the direction of the lines of electric force EL is the reverse direction with respect to the direction of the pretilt.

The alignment states of the liquid crystal molecules arranged in the perpendicular direction (the Z-axis direction) in the vicinity of the first electrode 21 in the forward region FR (the region on the left side of the central axis 21cx in the schematic cross-sectional view of FIG. 5) and the reverse region RR (the region on the right side of the central axis 21cx) are shown in the lower portion of the schematic cross-sectional view. In other words, the liquid crystal alignment state in the vicinity of the first electrode 21 provided in the forward region FR is illustrated by liquid crystal molecules 35a to 35c arranged in the perpendicular direction; and the liquid crystal alignment state in the vicinity of the first electrode 21 provided in the reverse region RR is illustrated by liquid crystal molecules 35d to 35f arranged in the perpendicular direction. In each illustration, the liquid crystal alignment states (the liquid crystal molecules arranged in the vertical direction) prior to and after the action of the lines of electric force EL most proximal to the first electrode 21 are displayed next to each other directly under the corresponding first electrode 21. On the left side, the direction of the lines of electric force EL is illustrated to overlap the liquid crystal alignment state prior to the voltage application. On the right side, the liquid crystal alignment state that is changed by the action of the lines of electric force EL is shown.

In the forward region FR, the tilt direction of the liquid crystal molecules 35a that are acted upon by the lines of electric force EL most proximal to the right of the center of the first electrode 21 is the same direction as the tilt direction of the liquid crystal molecules 35b above the liquid crystal molecules 35a. In such a case, the director in the vicinity on the right of the center of the first electrode 21 tilts; and the horizontal component of the director increases easily. The refractive index in the vicinity on the right of the center of the first substrate unit 11s increases.

In the forward region FR, the liquid crystal molecules 35c in the vicinity of the second substrate unit 12s in the region directly above the first electrode 21 tilt upward along the lines of electric force EL that extend in the perpendicular direction (the Z-axis direction).

As a result, the horizontal component of the director decreases; and the refractive index in the vicinity of the second substrate unit 12s decreases. The two effects are mutually-compensating. Therefore, the decreasing tendency of the refractive index in the upper proximal region to the right of the center of the first electrode 21 is suppressed.

In the reverse region RR (the region on the right side of the central axis 21cx in FIG. 5), the tilt direction of the liquid crystal molecules 35d that are acted upon by the lines of electric force EL most proximal to the left of the center of the first electrode 21 is the reverse direction of the tilt direction of the liquid crystal molecules 35e above the liquid crystal molecules 35d. On the liquid crystal molecules 35d, the rotational torque toward the lines of electric force EL and the rotational torque toward the proximal liquid crystal molecules 35e are mutually-compensating. Therefore, the liquid crystal molecules 35d most proximal to the left of the center of the first electrode 21 do not tilt easily. In the case where the electric field EL is extremely strong, the liquid crystal molecules 35 most proximal to the first electrode 21 tilt to be reversely oriented with respect to the liquid crystal molecules 35e; and deformation of bend alignment is formed. The middle portion of the bend alignment has the vertical alignment. In the region to the left of the center of the first electrode 21, most of the perpendicular component of the director is maintained for the liquid crystal layer 30 as an entirety.

In the vicinity of the second substrate unit 12s in the region directly above the first electrode 21 in the reverse region RR, the liquid crystal molecules 35f tilt upward along the lines of electric force EL that extend in the perpendicular direction (the Z-axis direction). As a result, the horizontal component of the director decreases; and the refractive index in the vicinity of the second substrate unit 12s decreases. Therefore, in the region to the left of the center of the first electrode 21, the compensation effect of the forward region FR does not occur; and the decrease amount of the refractive index becomes large.

Thus, in the configuration of the reference example in which the second electrode 22 is disposed at the center between the two first electrodes 21, the change amount (e.g., the decrease amount) of the refractive index is different between the forward region FR and the reverse region RR. As a result, the peak position of the refractive index does not overlap the position of the central axis 21cx between the first electrodes 21. In the example, the peak position of the refractive index is moved in the left direction from the central axis 21cx in the drawing. Therefore, the refractive index distribution Rx is laterally asymmetric (asymmetric around the central axis 21cx).

FIG. 6 is a schematic cross-sectional view showing the configuration of the liquid crystal optical element according to the first embodiment.

The first alignment film 31 and the second alignment film 32 are not shown in FIG. 6.

In the liquid crystal optical element 110 according to the embodiment as shown in FIG. 6, the second electrode 22 is asymmetric with respect to the central axis 21cx between the two first electrodes 21. In the example, the second electrode 22 is provided at a position that is shifted to the right from the central axis 21cx. Thereby, in the vicinity of the first electrode 21 in the forward region FR (the region on the left in FIG. 6), the lateral electric field component is weak; and the decrease of the refractive index is promoted. On the other hand, in the vicinity of the first electrode 21 in the reverse region RR (the region on the right in FIG. 6), the lateral electric field component is strong; and the refractive index decrease is suppressed. As a result, the difference of the decrease amount of the refractive index is small between the forward region FR and the reverse region RR. The refractive index distribution Rx becomes, for example, laterally symmetric or approaches lateral symmetry.

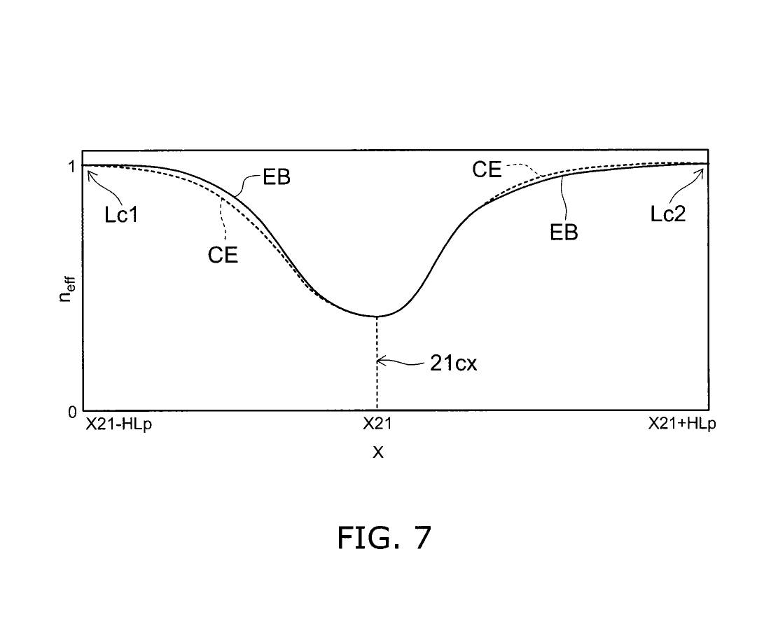

FIG. 7 is a graph showing characteristics of the liquid crystal optical elements.

FIG. 7 shows the refractive index distributions of the liquid crystal optical elements according to the reference example and the embodiment. The horizontal axis is the position in the X-axis direction. A position X21 corresponds to the position of the center of one first electrode 21. The position “X21-HLp” and the position “X21+HLp” correspond to the positions of the central axes 21cx. The central axes 21cx substantially correspond to the positions of lens centers (a lens center Lc1 on the left side and a lens center Lc2 on the right side) in the refractive index distribution Rx formed in the liquid crystal layer 30. The vertical axis of FIG. 7 is the refractive index n_{eff} of the liquid crystal layer 30. The refractive index n_{eff} is normalized by the value when no voltage is applied.

In FIG. 7, the solid line illustrates a refractive index distribution EB of the liquid crystal optical element 110 according to the embodiment. The broken line illustrates a refractive index distribution CE of the liquid crystal optical element 119 of the reference example.

The refractive index n_{eff} of the refractive index distribution CE of the reference example decreases smoothly from the lens center Lc1 on the left side to the central axis 21cx (the position X21). On the other hand, the decrease of the refractive index n_{eff} is suppressed near the central axis 21cx in the region between the central axis 21cx and the lens center Lc2 on the right side. The change of the refractive index n_{eff} is abrupt near the central axis 21cx in the region between the central axis 21cx and the lens center Lc2 on the right side.

On the other hand, in the refractive index distribution EB of the liquid crystal optical element 110 according to the embodiment, the gradient of the decrease of the refractive index n_{eff} between the lens center Lc1 on the left side and the central axis 21cx is more abrupt than the reference example. Further, the change of the refractive index n_{eff} between the central axis 21cx and the lens center Lc2 on the right side is smooth. In other words, the symmetry of the refractive index distribution EB of the embodiment is higher than the symmetry of the refractive index distribution CE of the reference example.

In the embodiment, the symmetry of the refractive index distribution Rx is improved by the second electrode 22 being asymmetric with respect to the central axis 21cx between the mutually-adjacent first electrodes 21.

In the embodiment, the first distance d12 in the X-axis direction between the second electrode 22 and the one electrode 21p of the two most proximal first electrodes 21 of the multiple first electrodes 21 is different from the second distance d21 in the X-axis direction between the other electrode 21q and the second electrode 22.

In the example, the pretilt on the second substrate unit 12s is oriented from the first substrate unit 11s toward the second substrate unit 12s along the +X axis direction in the X-axis direction from the one electrode 21p toward the other electrode 21q. The tilt of the director of the liquid crystal at the center of the liquid crystal layer 30 also is in the same direction. As an entirety, the liquid crystal layer 30 has a liquid crystal alignment in which the director of the liquid crystal is oriented from the first substrate unit 11s toward the second substrate unit 12s along the +X axis direction (the second direction) from the one electrode 21p toward the other electrode 21q. In such a case, the first distance d12 is longer than the second distance d21. Thereby, the symmetry of the refractive index distribution Rx can be improved. Thereby, the optical characteristics of the liquid crystal optical element 110 can be improved.

The asymmetry of the liquid crystal layer 30 includes not only the shift of the peak position of the refractive index distribution Rx but also the shift of the position of the bottom; and the shift amounts are not always the same. Therefore, even in the case where the symmetry of the refractive index distribution Rx is improved by shifting the position of the second electrode 22 as recited above, there are cases where a shift occurs between the period of the refractive index distribution and the period of the electrode disposition. Therefore, when disposing the pixel groups 50 of the image display unit 120 to overlap the liquid crystal optical element 110, it is desirable to adjust the positional relationship of the pixel groups 50 of the image display unit 120 and the liquid crystal optical element 110 beforehand to anticipate the shift.

### Second Embodiment

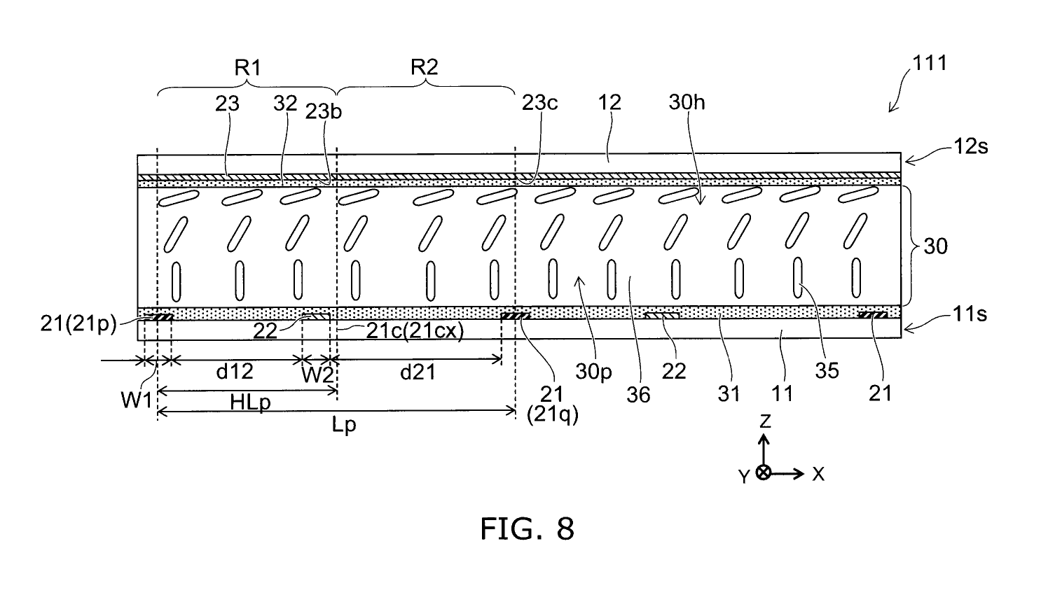

FIG. 8 is a schematic cross-sectional view showing the configuration of a liquid crystal optical element according to a second embodiment.

In the liquid crystal optical element 111 according to the embodiment as shown in FIG. 8, the second electrode 22 is shifted in the left direction from the central axis 21cx between the first electrodes 21.

In the liquid crystal optical element 111 as well, the second electrode 22 is asymmetric with respect to the central axis 21cx between the mutually-adjacent first electrodes 21. In the example, the first distance d12 in the X-axis direction between the second electrode 22 and the one electrode 21p of the two most proximal first electrodes 21 of the multiple first electrodes 21 is different from the second distance d21 in the X-axis direction between the other electrode 21q and the second electrode 22.

In the example, the liquid crystal layer 30 has a liquid crystal alignment in which the director of the liquid crystal is oriented from the first substrate unit 11s toward the second substrate unit 12s along the +X axis direction from the one electrode 21p toward the other electrode 21q. Also, the first distance d12 is shorter than the second distance d21.

For example, the absolute value of the difference of the distance, which is Δd (=|d21−d12|), is greater than at least one selected from the first width W1 and the second width W2. In the example, Δd is greater than the first width W1 and greater than the second width W2. The second electrode 22 is provided in the first region R1 between the central axis 21cx and the one electrode 21p of the two first electrodes 21. The second electrode 22 is not provided in the second region R2 between the central axis 21cx and the other electrode 21q of the two first electrodes 21.

Otherwise, the configuration of the liquid crystal optical element 111 is the same as the configuration of the liquid crystal optical element 110. The light modulation amount can be increased more for the liquid crystal optical element 111 than for the liquid crystal optical element 110. In other words, a liquid crystal optical element having a large light modulation amount and good optical characteristics can be provided.

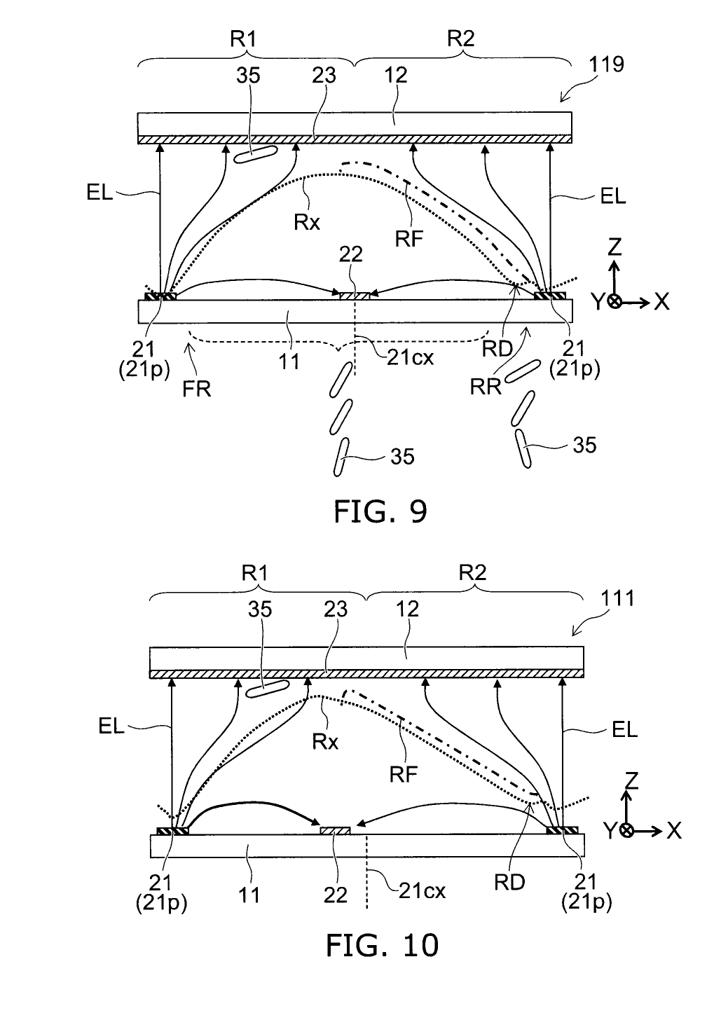

FIG. 9 is a schematic cross-sectional view showing the liquid crystal optical element of the reference example.

FIG. 9 shows a state in which the operating conditions of the liquid crystal optical element 119 shown in FIG. 5 are modified from those of the case of FIG. 5. In the state shown in FIG. 9, the voltage applied to the first electrodes 21 is higher than that of FIG. 5.

Deformation of bend alignment occurs in the vicinity of the first electrode 21 in the second region R2 of FIG. 9. A schematic view of the liquid crystal alignment state of the vicinity of the first electrode 21 is shown below the first electrode 21 provided in the second region R2. A jump RD (a minimum value) forms in the refractive index distribution Rx in the region between the one electrode 21p of the second region R2 and the central axis 21cx.

The deformation in the alignment of the nematic liquid crystal is classified into the three types of splay, twist, and bend. In many liquid crystals, the elastic constant corresponding to the bend deformation is the largest; and deformation occurs least easily. The range of the occurrence region of the bend alignment deformation is limited because the majority of the electrical energy that is input to the occurrence region is consumed by the deformation. Outside the bend alignment deformation region (in FIG. 9, the region spreading toward the left side), a liquid crystal alignment is formed in which the tilt of the liquid crystal director is uniform (a schematic view of the liquid crystal alignment state is shown below the second electrode 22). In the boundary region of the two regions, the liquid crystal director that is reversely tilted goes through a state of being tilted upward perpendicularly to be switched to the state of having the same tilt as the surroundings. In other words, in FIG. 9, following the boundary region of the two regions from the right to the left (in the -X axis direction), the horizontal component of the liquid crystal director decreases once from the state of being slightly large and again increases. As a result, the jump RD (the minimum value) is formed in the refractive index distribution Rx.

In such a case, the refractive index distribution due to the jump RD in the second region R2 behaves as the refractive index of a Fresnel lens jump (a refractive index distribution RF). As a result, the decrease amount of the refractive index is different between the left and right of the central axis 21cx in the configuration in which the second electrode 22 is disposed at the center between the first electrodes 21 (the refractive index distribution RF). In the case where a high voltage is applied to the liquid crystal optical element 119 of the reference example, the peak position moves to the right; and the refractive index distribution (the total of the refractive index distribution Rx and the refractive index distribution RF) becomes laterally asymmetric.

FIG. 10 is a schematic cross-sectional view showing a portion of the liquid crystal optical element according to the second embodiment.

FIG. 10 shows the refractive index distribution in a state in which a relatively high voltage is applied to the liquid crystal optical element 111 according to the second embodiment.

In the liquid crystal optical element 111 as shown in FIG. 10, the second electrode 22 is shifted in the −X axis direction from the central axis 21cx between the first electrodes 21. In the vicinity of the first electrode 21 in the second region R2 as shown in FIG. 10, the lateral electric field component is weak; and the jump effect of the refractive index is suppressed (the refractive index distribution RF). Conversely, in the vicinity of the first electrode 21 in the first region R1, the lateral electric field component is strong; and the refractive index decrease is suppressed. As a result, the difference of the change amount of the refractive index between the first region R1 and the second region R2 becomes small. As a result, the symmetry of the refractive index distribution (the total of the refractive index distribution Rx and the refractive index distribution RF) improves. Further, by the application of the high voltage in the embodiment, the change amount of the refractive index increases; and the difference between the maximum value and the minimum value of the refractive index distribution Rx increases.

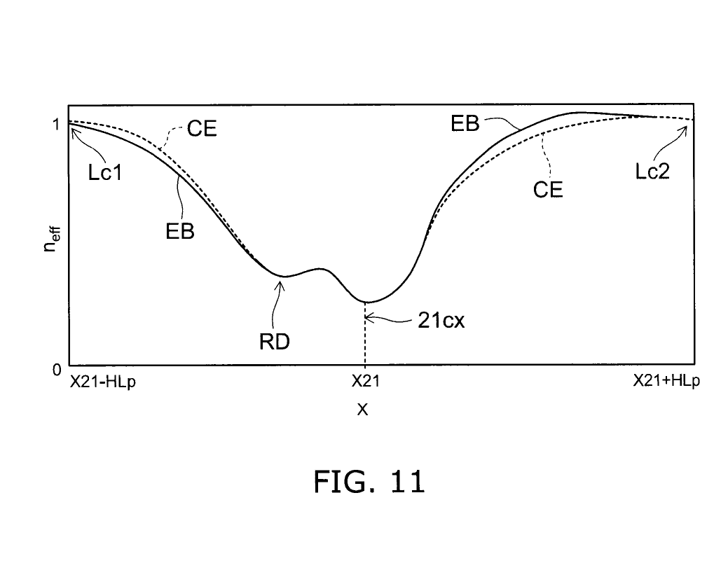

FIG. 11 is a graph showing characteristics of the liquid crystal optical elements.

FIG. 11 shows the refractive index distribution EB (the solid line) of the liquid crystal optical element 111 according to the second embodiment and the refractive index distribution CE (the broken line) of the liquid crystal optical element 119 of the reference example. In FIG. 11, similarly to FIG. 7, the horizontal axis is the X-axis direction position. The vertical axis is the refractive index n_{eff}.

In the refractive index distribution CE (the broken line) of the reference example, the jump RD (the minimum value) exists in the region between the lens center Lc1 of the left side and the central axis 21cx (the position X21). Due to the jump effect of the refractive index, the refractive index n_{eff} in the region between the lens center Lc1 on the left side and the central axis 21cx as an entirety is effectively higher than the refractive index n_{eff} in the region between the lens center Lc2 on the right side and the central axis 21cx.

Conversely, in the refractive index distribution EB (the solid line) according to the embodiment, the gradient of the change of the refractive index n_{eff} in the region between the lens center Lc1 on the left side and the central axis 21cx is lower than that of the reference example. On the other hand, the gradient of the change of the refractive index n_{eff} in the region between the lens center Lc2 on the right side and the central axis 21cx is higher than that of the reference example. In the embodiment, the symmetry of the refractive index distribution EB is improved. Further, the difference between the maximum value and the minimum value of the refractive index distribution Rx is greater for the refractive index distribution EB shown in FIG. 11 than for the refractive index distribution EB shown in FIG. 7.

In the embodiment, the liquid crystal layer 30 has a liquid crystal alignment in which the director of the liquid crystal is oriented from the first substrate unit 11s toward the second substrate unit 12s along the +X axis direction from the one electrode 21p toward the other electrode 21q. In such a case, the first distance d12 is shorter than the second distance d21. Thereby, the symmetry of the refractive index distribution Rx can be improved in the state in which the difference between the maximum value and the minimum value of the refractive index distribution Rx of the liquid crystal optical element is increased. Thereby, a liquid crystal optical element having a large light modulation amount and good characteristics can be realized.

### Third Embodiment

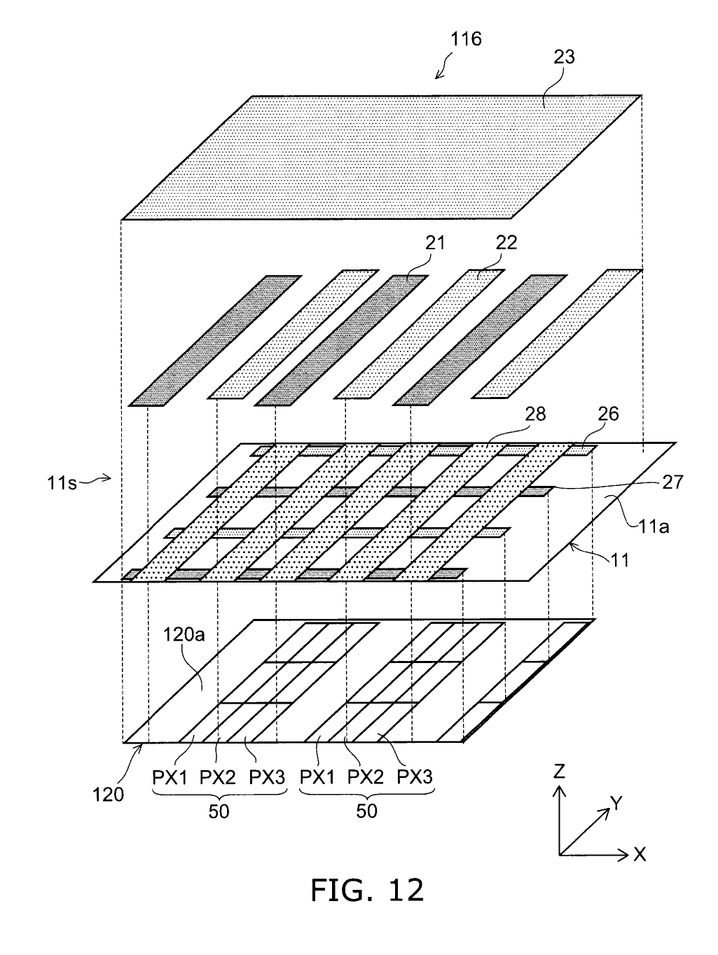

FIG. 12 is a schematic perspective view showing an image device according to a third embodiment.

In a liquid crystal optical element 116 as shown in FIG. 12, the first substrate unit 11s further includes multiple third electrodes 26 and multiple fourth electrodes 27 provided on the first major surface 11a. The first electrodes 21 and the second electrodes 22 extend in, for example, the first direction (the Y-axis direction). The third electrodes 26 extend along the X-axis direction. The multiple third electrodes 26 are disposed to be separated from each other in the Y-axis direction. The fourth electrodes 27 are disposed respectively between the multiple third electrodes 26. The pitch of two third electrodes 26 corresponds to, for example, the width of two pixel groups 50 arranged in the Y-axis direction. The spacing of the two third electrodes 26 may correspond to the width in the Y-axis direction of three or more pixel groups 50. In the example, the two pixel groups 50 arranged in the Y-axis direction oppose a region having a rectangular configuration that is defined by the multiple first electrodes 21 and the multiple third electrodes 26. In the first substrate unit 11s, an inter-layer insulating layer 28 is provided between the third electrodes 26 and the first electrodes 21, between the third electrodes 26 and the second electrodes 22, between the fourth electrodes 27 and the first electrodes 21, and between the fourth electrodes 27 and the second electrodes 22.

In the liquid crystal optical element 116, voltages can be applied individually to each of the multiple first electrodes 21, the multiple second electrodes 22, the multiple third electrodes 26, and the multiple fourth electrodes 27 because these electrodes are separated.

For example, a voltage is applied to the third electrodes 26; and the opposing electrode 23 and the fourth electrodes 27 are grounded. Thereby, in the liquid crystal optical element 116, a refractive index distribution having a cylindrical lens configuration along the X-axis direction can be formed in the liquid crystal layer 30.

For example, voltages are applied to the multiple first electrodes 21 and the multiple third electrodes 26; and the multiple second electrodes 22, the opposing electrode 23, and the multiple fourth electrodes 27 are grounded. Thereby, a refractive index distribution can be formed in the portion of the liquid crystal layer 30 opposing the region around which the first electrodes 21 and the third electrodes 26 are provided. For example, a refractive index distribution having a microlens configuration arranged in a matrix configuration in the X-axis direction and the Y-axis direction can be formed. Because the voltages can be applied individually to the multiple first electrodes 21, the multiple second electrodes 22, the multiple third electrodes 26, and the multiple fourth electrodes 27, any refractive index distribution can be formed; and the application range expands.

In such a case as well, the second electrode 22 is asymmetric with respect to the central axis 21cx. Thereby, a liquid crystal optical element and an image display device (an image device) that have good optical characteristics can be provided.

### Fourth Embodiment

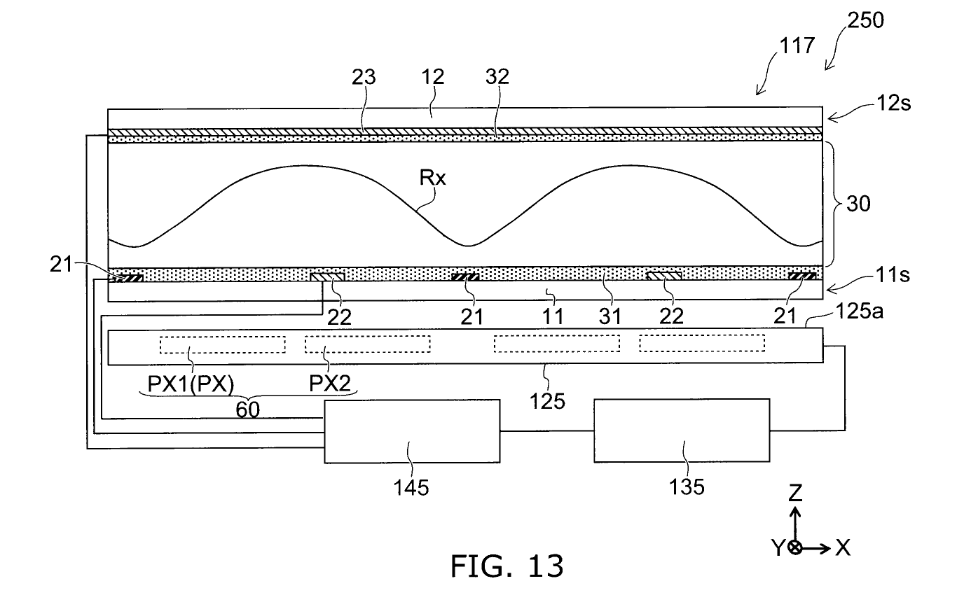

FIG. 13 is a schematic cross-sectional view showing an image device according to a fourth embodiment.

The image device according to the embodiment is an imaging device 250.

The imaging device 250 includes a liquid crystal optical element 117, an imaging unit 125 (an image unit), an imaging control circuit 135, and a control circuit 145. The imaging unit 125 includes pixels. The configuration of the liquid crystal optical element 117 is the same as, for example, the configuration of the liquid crystal optical element 110, the liquid crystal optical element 111, or the liquid crystal optical element 116 recited above.

The liquid crystal optical element 117 is provided on an imaging surface 125a of the imaging unit 125. The liquid crystal optical element 117 covers the entire imaging surface 125a and functions as a liquid crystal GRIN lens.

The imaging control circuit 135 is electrically connected to the imaging unit 125. The control circuit 145 is electrically connected to the liquid crystal optical element 117. The imaging control circuit 135 controls the operation of the imaging unit 125.

The control circuit 145 is connected to, for example, the imaging control circuit 135. The control circuit 145 controls the image projected on the imaging surface 125a based on a signal supplied from the imaging control circuit 135. The imaging control circuit 135 may be included in the imaging unit 125. The imaging control circuit 135 may include the control circuit 145.

The imaging unit 125 senses the image that is projected via the liquid crystal optical element 117 onto the imaging surface 125a. The imaging control circuit 135 processes the image signal that is sensed. Various images can be imaged by the imaging device 250 controlling the liquid crystal optical element 117.

In such a case as well, the second electrode 22 is asymmetric with respect to the central axis 21cx. Thereby, a liquid crystal optical element and an imaging device that have good optical characteristics are provided.

The period of the lenses may match the period of pixel groups 60 as shown in FIG. 13; and there are cases where the period of the lenses does not match the period of the pixel groups 60. Also, the imaging device 250 may have a configuration that further includes an imaging lens system above the liquid crystal optical element 117.

According to the embodiments, a liquid crystal optical element and an image device that have good optical characteristics can be provided.

Hereinabove, embodiments of the invention are described with reference to specific examples. However, the invention is not limited to these specific examples. For example, one skilled in the art may similarly practice the invention by appropriately selecting specific configurations of components included in the liquid crystal optical element such as the first substrate unit, the second substrate unit, the liquid crystal layer, the first substrate, the second substrate, the first electrode, the second electrode, and the opposing electrode, specific configurations of components included in the image device such as the control circuit, etc., from known art; and such practice is included in the scope of the invention to the extent that similar effects are obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A liquid crystal optical element, comprising:
a first substrate unit including
a first substrate having a first major surface,
a plurality of first electrodes provided on the first major surface to extend along a first direction, and
a second electrode provided between two most proximal first electrodes of the plurality of first electrodes on the first major surface, and extending along the first direction, the second electrode being asymmetric with respect to a central axis, the central axis being parallel to the first direction, and passing through a midpoint of a line segment connecting a center in a second direction of one electrode of the two most proximal first electrodes to a center in the second direction of the other electrode of the most proximal first electrodes, the second direction being parallel to the first major surface and perpendicular to the first direction;
a second substrate unit including
a second substrate having a second major surface opposing the first major surface, and
an opposing electrode provided on the second major surface to oppose the first electrodes and the second electrode; and
a liquid crystal layer provided between the first substrate unit and the second substrate unit, and having a first portion on the first substrate unit side and a second portion on the second substrate unit side, a liquid crystal in the first portion having a vertical alignment, a liquid crystal in the second portion having a horizontal alignment along the second direction.

2. The element according to claim 1, wherein a first distance in the second direction between the one electrode and the second electrode is different from a second distance in the second direction between the other electrode and the second electrode.

3. The element according to claim 2, wherein
the liquid crystal layer has a liquid crystal alignment including a director of the liquid crystal oriented from the first substrate unit toward the second substrate unit along the second direction from the one electrode toward the other electrode, and
the first distance is longer than the second distance.

4. The element according to claim 2, wherein
the liquid crystal layer has a liquid crystal alignment including a director of the liquid crystal oriented from the first substrate unit toward the second substrate unit along the second direction from the one electrode toward the other electrode, and
the first distance is shorter than the second distance.

5. The element according to claim 1, wherein
the plurality of first electrodes is disposed at uniform spacing in the second direction, and
the second electrode is disposed respectively between mutually-adjacent first electrodes, and a plurality of the second electrodes is disposed at uniform spacing.

6. The element according to claim 1, wherein the second electrode is provided in one region between the two first electrodes partitioned by the central axis, and the second electrode is not provided in the other region between the two first electrodes partitioned by the central axis.

7. The element according to claim 1, wherein a dielectric anisotropy of the liquid crystal layer is positive or negative.

8. The element according to claim 1, wherein
the first substrate unit includes a first alignment film between the liquid crystal layer and the first electrodes and between the liquid crystal layer and the second electrode, the first alignment film causing a director of the liquid crystal to have the vertical alignment, and
the second substrate unit includes a second alignment film between the liquid crystal layer and the opposing electrode, the second alignment film causing the director of the liquid crystal to have the horizontal alignment.

9. The element according to claim 8, wherein a surface energy of the second alignment film is greater than a surface energy of the first alignment film.

10. The element according to claim 1, wherein the liquid crystal has a HAN (Hybrid Aligned Nematic) alignment in a state in which a voltage is not applied between the opposing electrode and the first electrodes and between the opposing electrode and the second electrode.

11. The element according to claim 1, wherein
a pretilt angle of the horizontal alignment is not less than 0 degrees and not more than 30 degrees, and
a pretilt angle of the vertical alignment is not less than 60 degrees and not more than 90 degrees.

12. An image device, comprising:
a liquid crystal optical element including
a first substrate unit including
a first substrate having a first major surface,
a plurality of first electrodes provided on the first major surface to extend along a first direction, and
a second electrode provided between two most proximal first electrodes of the plurality of first electrodes on the first major surface to extend along the first direction, the second electrode being asymmetric with respect to a central axis, the central axis being parallel to the first direction to pass through a midpoint of a line segment connecting a center in a second direction of one electrode of the two most proximal first electrodes to a center in the second direction of the other electrode of the most proximal first electrodes, the second direction being parallel to the first major surface and perpendicular to the first direction,
a second substrate unit including
a second substrate having a second major surface opposing the first major surface, and
an opposing electrode provided on the second major surface to oppose the first electrodes and the second electrode, and
a liquid crystal layer provided between the first substrate unit and the second substrate unit, and having a first portion on the first substrate unit side and a second portion on the second substrate unit side, a liquid crystal in the first portion having a vertical alignment, a liquid crystal in the second portion having a horizontal alignment along the second direction; and
an image unit disposed to overlap the liquid crystal optical element, the image unit including a pixel.

13. The device according to claim 12, wherein
the device further comprises a control circuit electrically connected to the first electrodes, the second electrode, and the opposing electrode, and
the control circuit controls a potential of the first electrodes, a potential of the second electrode, and a potential of the opposing electrode so as to cause a refractive index distribution of the liquid crystal layer to monotonously increase along a direction from the one electrode toward the second electrode, and so as to cause the refractive index distribution of the liquid crystal layer to monotonously increase along a direction from the other electrode toward the second electrode.

14. The device according to claim 12, wherein
the device further includes a control circuit electrically connected to the first electrodes, the second electrode, and the opposing electrode, and
the control circuit controls a potential of the first electrodes, a potential of the second electrode, and a potential of the opposing electrode so as to form a minimum value in a refractive index distribution of the liquid crystal layer in at least one region selected from a region between the one electrode and the second electrode and a region between the other electrode and the second electrode.

15. The device according to claim 14, wherein
the liquid crystal layer has a liquid crystal alignment including a director of the liquid crystal oriented from the first substrate unit toward the second substrate unit along the second direction from the one electrode toward the other electrode, and
the control circuit is configured to form the minimum value of the refractive index distribution in the region between the other electrode and the second electrode.

16. The device according to claim 12, wherein a first distance in the second direction between the one electrode and the second electrode is different from a second distance in the second direction between the other electrode and the second electrode.

17. The device according to claim 12, wherein the liquid crystal optical element serves as a liquid crystal GRIN lens (Gradient Index lens) in a state in which a voltage is applied between the opposing electrode and the first electrodes and between the opposing electrode and the second electrode.

18. The device according to claim 17, wherein the liquid crystal optical element converts an image displayed by the image unit into a plurality of parallax images.

19. The device according to claim 12, wherein
the device further includes a control circuit electrically connected to the first electrodes, the second electrode, and the opposing electrode, and
the control circuit displays and switches a two-dimensional image of the image unit to a three-dimensional image by applying a voltage between the opposing electrode and the first electrodes and between the opposing electrode and the second electrode.

20. The device according to claim 12, wherein
the device further includes a control circuit electrically connected to the first electrodes, the second electrode, and the opposing electrode, and
the control circuit controls an image projected by the image unit by applying a voltage between the opposing electrode and the first electrodes and between the opposing electrode and the second electrode.
